(19) United States
(12) Patent Application Publication
(10) Pub. No.: US 2016/0052253 A1
(43) Pub. Date: Feb. 25, 2016

(54) FLEXIBLE PRESSLINE UTILIZING MODULAR PRINT ZONES

(71) Applicant: Phillip DiGenova, Tierra Verde, FL (US)

(72) Inventor: Phillip DiGenova, Tierra Verde, FL (US)

(21) Appl. No.: 14/832,552

(22) Filed: Aug. 21, 2015

Related U.S. Application Data
(60) Provisional application No. 62/040,769, filed on Aug. 22, 2014.

(51) Int. Cl. B41F 13/06

(52) U.S. Cl. CPC B41F 13/06

(57) ABSTRACT

A flexible pressline which utilizes a non-linear arrangement of the folder to the press units. Specifically, the folder is not in-line with the press units but is arranged at a generally 90 degree angle out-of-line and offset with them. The flexible pressline may be comprised of two or more modular print zones (comprising press units and paper sources) which are combined with at least one folder zone (comprising a folder) and a turn zone (comprising angle bars or similar paper web directing items) to form a pressline module. Multiple pressline modules may be combined to form a pressline which serves to provide the printing capacity of the location.

### CROSS REFERENCE TO RELATED APPLICATIONS

This application claims benefit of U.S. Provisional Patent Application No. 62/040,769, filed Aug. 22, 2014, the entirety of which is herein incorporated by reference.

### BACKGROUND

1. FIELD OF THE INVENTION

The present invention relates to a newspaper pressline. Particularly to a pressline which utilizes at least one folder arranged non-parallel with the press units.

2. DESCRIPTION OF THE RELATED ART

The advent of the Internet and the digital reader has created a whole new world for the newspaper business. The number of people who read a daily newspaper that has been printed on paper is declining rapidly, having almost halved since 2004. Even with this trend, however, the printed newspaper is still a very big business and the publication of paper printed daily news is still quite a vibrant market. The increase in online readership has combined with traditional paper readership in a unique way and a traditional newspaper in today's day and age will often publish content in a variety of different forms to meet the needs of its readers. Firstly, most still publish traditional paper forms of their newspaper in addition to their online and mobile editions to capture the share of the market interested in a paper presentation. Further, it is noted that many readers actually read both forms, making the paper edition still a valuable commodity even as readership increasingly moves online.

At the same time, the decline in physical paper readership has presented a unique dilemma. In particular, the paper distribution of a “large market” newspaper today is only about the same as what a “midmarket” newspaper was 20 or 30 years ago. However, the capital infrastructure to generate a print newspaper can be enormous and last for a very large number of years. Previously, due to physical printing constraints, papers with a large readership base (large market newspapers) were very dependent on speed to produce enough papers to meet demand. For the most part, speed was generally most limited by the size of the pressline, and specifically how many pages it could print at a time. As there is effectively a maximum number of press units that can feed any one folder and therefore make a paper of a desired size, presslines in major markets were generally large and were arranged in repeating rows of press units and in-line folders to provide speed.

For the most part, a major market pressline would include 8-10 press units (often with 3 or 4 blanket/roller combinations) with each folder. Further, these press units were often “double wide” which allowed for each press to turn out two copies of each page (or two different pages) side-by-side at the same time. The newspaper would then have multiples of these linear presslines operating side-by-side either turning out multiple copies (of a smaller edition) or parts of a larger edition which could be further assembled downstream.

While these large in-line presslines are very powerful, very fast for printing a large paper, and quite simple, they have a couple of major problems. In the first instance, they generally lack flexibility. Because the presslines were generally arranged linearly, with the paper rolls being positioned at both ends, the folder in the middle and two in-line rows of press units extending from both sides of the folder to the respective paper sources, the flow of the various paper webs through the pressline was relatively defined.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art described herein, among other things, is a pressline which utilizes a non-linear arrangement of the folder to the press units. Specifically, the folder is not in-line with the press units but is arranged at a generally 90 degree angle with them.

Described herein, in an embodiment, is a pressline comprising: a first press zone comprising at least two press units arranged in-line with each other and a paper source supplying a paper web to each of the press units; a first folder zone comprising at least one folder, the first folder zone being out-of-line and offset to a first side of the press units; and a turning zone comprising angle bars, the angle bars being positioned so as to take at least one paper web from at least one of the press units and redirect the paper web to the folder; wherein the at least one paper web in the turning zone is redirected from being in-line with the press units and out-of-line with the folder to being out-of-line with the press units and in-line with the folder.

In an embodiment of the pressline, the at least one paper web in the turning zone is redirected generally about 90 degrees.

In an embodiment, the pressline, further comprises a second folder zone, the second folder zone comprising at least one folder, the second folder zone being out-of-line and offset to a second side of the press units.

In an embodiment, the pressline, further comprises a second press zone, the second press zone comprising at least two press units arranged in-line with each other and a paper source supplying a paper web to each of the press units in the second press zone, the second press zone facing the first press zone.

There is also described herein a pressline module comprising: at least two press units; at least two folders; and at least one turn zone comprising angle bars; wherein a first of the at least two press units is arranged facing the turn zone; wherein a second of the at least two press units is arranged on an opposing side of the turn zone to the first of the at least two press units, is facing the turn zone, and is in-line with the first of the at least two press units; wherein a first of the at least two folders is arranged out-of-line with the press units, offset from the press units, and facing the turn zone; and wherein a second of the at least two folders is arranged on an opposing side of the turn zone to the first of the at least two folders, in-line with the first of the at least two folders, out-of-line with the press units, offset from the press units, and facing the turn zone.

In an embodiment, the pressline module further comprises at least one paper source supplying a paper web to the press units.

In an embodiment of the pressline module, the at least two press units comprises at least six press units.

In an embodiment of the pressline module, the press units are arranged in at least three groups of press units; wherein a first of the at least two press units in a first group is arranged facing the turn zone and a second of the at least two press units in the first group is arranged on an opposing side of the turn zone to the first of the at least two press units, is facing the turn zone, and is in-line with the first of the at least two press units in the first group; wherein a first of the at least two press units in a second group is arranged facing the turn zone and a second of the at least two press units in the second group is arranged on an opposing side of the turn zone to the first of the at least two press units, is facing the turn zone, and is in-line with the first of the at least two press units in the second group; wherein a first of the at least two press units in a third group is arranged facing the turn zone and a second of the at least two press units in the third group is arranged on an opposing side of the turn zone to the first of the at least two press units, is facing the turn zone, and is in-line with the first of the at least two press units in the third group.

In an embodiment of the pressline module, there are at least twelve press units and each of the at least three groups of press units comprises at least two press units.

In an embodiment of the pressline module, there are at least eighteen press units and each of the at least three groups of press units comprises at least three press units.

In an embodiment a pressline is formed of any combination of any of the proceeding pressline modules.

### BRIEF DESCRIPTION OF DRAWINGS

FIG. 1 provides a side view of an embodiment of a linearly arranged pressline of the prior art.

FIG. 2 provides a perspective view of an embodiment of a pressline module. For purposes of orientation, the viewer is indicated to be at the top left of the module.

FIG. 3 provides for a second perspective view of the embodiment of the pressline module of FIG. 2. For purposes of orientation, the viewer is indicated to be at the bottom right of the module.

FIG. 4 provides a plan view of the embodiment of FIG. 2 but including a different secondary folder. For purposes of orientation, the viewer would be considered to be looking at the front of the module. However, this view would generally correspond to a floor plan or footprint indication.

FIG. 5A provides for an embodiment of a two press unit print zone. FIG. 5B provides for an embodiment of a three press unit print zone.

FIG. 6 provides for a combined block diagram illustrating how paper webs can pass through a pressline module with five active print zones and a single active folder zone.

FIG. 7 shows how paper webs feeding an in-line folder from the two facing halves (each of which has two press units) of a prior art pressline cannot be interleaved.

FIGS. 8A, 8B, 8C, and 8D show the possible interleaf patterns of paper webs from two facing print zones of FIG. 5A can be interleaved prior to being directed to a folder which would generally be at the position of the viewer.

FIG. 9 provides a perspective for a large pressline which comprises five pressline modules with a couple of different configurations of print zones and folders. In FIG. 9, as opposed to FIGS. 2-4, the print zones are arranged on a single side and face only one direction.

FIG. 10 provides a floor plan of another embodiment of a large pressline which comprises three pressline modules. As in FIG. 9, the print zones are arranged on a single side and face only one direction.

### DESCRIPTION OF THE PREFERRED EMBODIMENT(S)

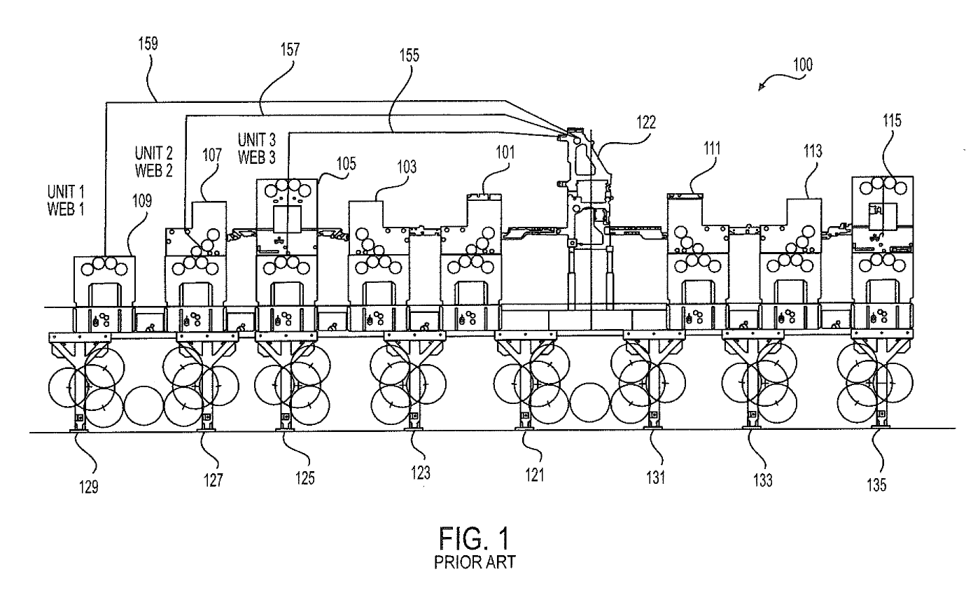

FIG. 1, shows a side view of a pressline (100) of the prior art. This pressline (100) is not balanced having five press units (101), (103), (105), (107) and (109) on one side of the folder (122) and three press units (111), (113) and (115) on the other. Further, the various press units are of various different types. For example press unit (109) is a standard unit which can only print a single color on two sides of the page (generally black to make a black and white page) while units (101), (103), (107), (111), and (113) are half towers which are capable of printing three colors either on one side of the page, or with one color on both sides and a further color on only one side. Further, units (105) and (115) are tower press units which can print all four colors (full color) on one side of the page, or two colors on each side of the page.

The layout of FIG. 1 places the paper rolls (121), (123), (125), (127), (129), (131), (133) and (135) underneath an associated press unit. This is an alternative layout to positioning paper at the ends of the pressline that is also relatively common and generally provides for more paper sources. In other arrangements, the paper rolls may also be located on the side of the press units to save space, but the exact location is not important to the discussion of these presslines. As should be apparent from FIG. 1, the paper flow (which is generally called a paper web) from the roll to the folder (where the paper is cut and folded) requires a long distance of travel and a particular pattern.

Specifically, in order to print particular paper pages with particular colors (based on the press units available to the pressline), the paper web will generally have multiple rolls of paper, and each paper web will be routed to a particular press unit or units to allow that paper web to be printed with any of 1 to 4 colors depending on if the printed pages are black and white, spot color, or full color. For simplicity of discussion, it should be recognized that the web from an individual roll needs to pass by a number of plate/blanket sets per side, for each color printed. Thus, a full color sheet on both sides needs 4 roller sets contacting each side of the paper. To use a simple example of paper flow, there are shown three hypothetical webs where each paper source (129), (127) and (125) directly feeds the print unit (109), (107) and (105) above it. This is very simple and would create a first paper web (159) which is black and white on both sides, a second paper web (157) which is black and white on one side and black and white with a spot color (e.g. red) on the other, and a third paper web (155) which has black and white with spot color on both sides.

These paper webs (155), (157), and (159) have to be sent into the folder in a particular arrangement. In particular, the first web (159) has to be on top of second web (157) which has to be on top of third web (155). Thus, the first web (159) will necessarily have the outermost pages (first and last, and therefore also second and second to last which are printed on the opposing sides) of the resultant paper. As should be apparent, alteration of this pattern is essentially impossible as trying to move the web (159) underneath other webs would require it to “pass through” the lower web. While it is possible to send the web (159) underneath, the need to bend the web (159) around the other webs (155) and (157) is sufficiently complicated (e.g. it requires moving outside the line of the webs and machines) to mean it would only happen in extreme circumstances.

While the above layout is simple, other patterns can be used but they also come with specific page restrictions. For example, a paper web could flow from source (129) through press unit (109), and then through the lower part of unit (107) and all of unit (105) (which would do full color on both sides) or from press unit (109) through the tops of units (107), (103), and (101) to provide full cover on the outside pages (first and last), but black and white on the backside (second and second to last pages). However, in this type of arrangement, the ability to use other units is severely limited. For example, in the first arrangement (full color on both sides) the paper source (127) would likely be unusable as all its potential paths are blocked by the paper web from source (129) and the upper portion of press unit (107) couldn't be used. Similarly, in the second arrangement, the lower portion of press unit (107) could generally only be used to print a full color page (using the lower portions of press unit (107), (105), (103) and (101)).

As should be apparent, this pressline has very little flexibility in page layout. Further, once a particular matrix of webs is chosen, it can be difficult to alter the pattern even if a particular page isn't needed in a particular edition. The fixed nature of web flow is so institutionalized as to be part of the operating materials of numerous presses for example, the necessary page layout, plate positioning, and web flow for presslines utilizing certain presses is provided in the “Pressman' Manual 268 Rockwell-Goss Urbanite Unit” and the “Pressman's Manual 235 Rockwell-Goss Cosmo-Offset Unit”. Both the above are published by Rockwell International and the entire disclosure of both of which is incorporated herein by reference.

The reason for the fixed page layout has to do with the fact that the pages travel as a web and not as sheets and, thus, the web leaving press unit (109) cannot easily pass under a web leaving any other unit. Because of the need for the uppermost web to be the outermost pages, it therefore will generally mean that the output of press unit (109) will comprise the outermost pages of a section of each edition, even if that particular section does not need to use all the press units (101), (103), (105), (107), and (109) to print the desired pages in the desired colors.

This paper web positioning is problematic in a number of respects. In the first instance, the furthest unit from the folder often provides a web which requires the greatest amount of imparted tension to move from the press unit to the folder. In particular, there are generally three points at which the web can be grabbed by machine and the tension is based on the ability to control the web between those points with greater tension being necessary for greater distance. The first point is at the web roll itself, the second point is at the press unit, and the third is at the folder. The longer the distance between those points, the more tension that needs to be applied to the web to get it where it needs to go.

Even in a scenario where the first distance is the same or similar for all the webs (e.g. that depicted in FIG. 1 where the distance from any paper source to the press unit above it is generally similar to the distance of any other similar combination), the furthest press unit from the folder (122) (press unit (109) in FIG. 1) has the longest distance between the last two items and therefore the least control over the web tension as the web enters the folder. This can create wrinkling problems as the topmost web upon entering the folder is generally under the most tension.

As discussed above, because of the nature of paper web feeds, it is generally necessary to utilize the furthest unit to print each day's paper. While certain papers may be smaller (e.g. a weekday vs. a Sunday), because of the fact that the webs will often remain connected through their entire paths (and just not in use) one can generally not utilize a later unit to print page one for a paper of any size as that would require modifying the paper flow from a variety of units and is not cost effective. Because of these issues, presslines have traditionally been built in a manner such that the paper's layout of sections is chosen and the press is built to provide it. Different editions then may maneuver different parts of the sections around (e.g. one pressline may print section B on one day and section D on another), but the paper flow through any pressline is generally relatively fixed once the pressline is built.

A second problem with the arrangement of these very large and powerful press lines is that when press units are not in use for printing the paper they are arranged for, they can often not be used in other tasks. For example, it can be beneficial for a large pressline that is not being fully utilized to print its current product, to be printing inserts for the paper for a later version (e.g. printing components for the Sunday while the Saturday is printing) or in contract printing where the printer is printing a product for a separate party while simultaneously printing its paper. While there is some flexibility of the systems to provide this type of printing, that flexibility is generally carefully bounded and only specific formats and arrangements can be printed. Thus, parts of the pressline are commonly left to sit idle.

Because of the required paper flow, there is a limit the types of inserts that can be prepared ahead of time, and the types of contracts the presslines can be used to fulfill. Specifically, the internal units are often those available for contract printing because the outermost units are necessary to print the paper, but the output of these internal units is often “fenced in” by the paper webs of the outermost units, and therefore they may only be able to operate if there is a second folder at a precise location, or it may be the case where these units can be setup, but not run, while the other units are running Thus, it will often be the case that the full pressline is never really running except for the biggest editions. These types of problems are exaggerated when a pressline utilizes double wide press units as these provide for enormous speed and pagination increases, but at an additional cost of flexibility since they have to print pages side by side.

One other problem with traditional high speed presslines that can provide large amounts of printing is that they are generally arranged linearly. This allows for a more straightforward web flow and ease in arranging the various pages. At the same time, this can provide for difficult architectural requirements as buildings housing the press lines often have to be long and narrow which is not a common building shape.

Because of all the problems above, large newspapers which used to have wide paper distribution are currently stuck with machinery that is designed to produce far more printed matter than there is demand for. As the demands for their paper product have fallen, they are left with a idling capital investment built to produce far more papers than is needed. Interestingly, a number of smaller presses, which may lack the raw capacity but have the flexibility because they are smaller, are more suited to the changing environment. Thus, when they see their paper readership decline, they may be able to more readily utilize their presslines in different fashions.

Because of these and other problems in the art, there is a need for a pressline which provides for flexibility in paper web flow so that it can print a variety of different sized products and can allow for excess capacity to be utilized in printing other materials. Further, in order to provide for a more readily constructible system, it is preferable that the system have a less linear footprint and be provided in a modular fashion where build out of a press to accommodate greater printing needs (should they arise) is relatively straightforward.

In order to understand the present disclosure, it is desirable to standardize the terminology in which it is discussed. Therefore, for purposes of this application: A “press unit” is considered a well understood self-contained rotary press of the type commonly used for newspaper printing. A non-limiting embodiment of a press unit is a Urbanite™ produced by Goss Corporation. The press unit will generally have from 1 to 4 plate cylinders upon which are positioned plates for an image to be printed. There is associated with each plate a blanket cylinder Ink flows onto the image onto a plate, which then transfers ink onto the blanket cylinder, where it is transferred to paper. This allows the plates to be positive (as opposed to negative) images of the resultant paper page. In order to transfer the image to paper, the paper will be pressed between two blanket cylinders (so both sides are printed simultaneously) or a blanket cylinder will push the paper between itself and a common image cylinder, which does not print but provides resistance allowing printing of a single side.

A press unit may print any number of images in each rotation of each plate cylinder. Generally, this will be either one image (one-around), two images (two-around), or three images (three-around). A press may be “single wide” which means that it prints a paper web the width of a single quadrifold newspaper (which is actually four pages of the paper) or smaller, a “three page” which means it prints a web comprising six pages of a newspaper (these are generally split into a single quadrifold and a single singlefold sheet by a slitter or the folder) or smaller, or a “double wide” which prints a web two quadrifold pages side by side (8 pages of a newspaper) or smaller.

A “folder” is a device which serves to cut apart the printed paper pages from a paper web and fold them into a single publication, or section of a publication, depending on size and operation. A folder can operate in two traditional modes. A “collect” run makes the standard quadrifold newspaper with individual sections. A “straight” run allows for the pages to be collected and center folded (single fold) in the manner of a book, magazine, or a newspaper tabloid. Many folders can fold two sections side by side where the sections are divided at the center line of the folder. Smaller folders may only be able to fold a single section.

A “pressline” is a collection of at least one press unit, at least one folder, and a paper web. A traditional pressline will comprise 4-10 press units arranged in-line with a centrally positioned folder also arranged in-line and at least one paper source. Alternatively, the press units on one side of the folder may be offset from the units on the other producing two parallel but not co-axial web paths. This would be common if two single wide press units were feeding a two section folder.

The pressline also will include other elements such as “angle bars”, which serve to alter the direction of the paper web at any point to direct it to a desired location, and may include devices such as “slitters” which are designed to split the paper web into sub-webs. Specifically, a slitter is designed to cut the paper web lengthwise (e.g. to separate the pages of a double wide or three page press unit) as opposed to the folder which is designed to cut the paper web crosswise and may also cut it lengthwise in the case of a wider folder. Use of slitters is generally not preferred in a pressline as after slitting it is generally very difficult to control the tension of both sub webs. Thus, it is generally preferred in the industry that all cutting of the web occur in the folder.

A “paper web” comprises the paper while it is still in a multi-sheet extended form. A “paper web” will generally be provided on a continuous roll which is unrolled as multiple newspaper pages are printed along its length. The roll will generally be located at a “paper source” located near the press units. The paper web will generally unroll and be presented through various press units for printing and will eventually enter the folder. Only once the folder has cut individual sheets from the web does the paper web cease being a web and become individual paper sheets.

Provided herein is a flexible pressline which is comprised of two or more modular print zones (comprising press units and paper sources) which are combined with at least one folder zone (comprising a folder) and a turn zone (comprising angle bars or similar paper web directing items) to form a pressline module. Multiple pressline modules may then be combined to form a pressline which serves to provide the printing capacity of the location.

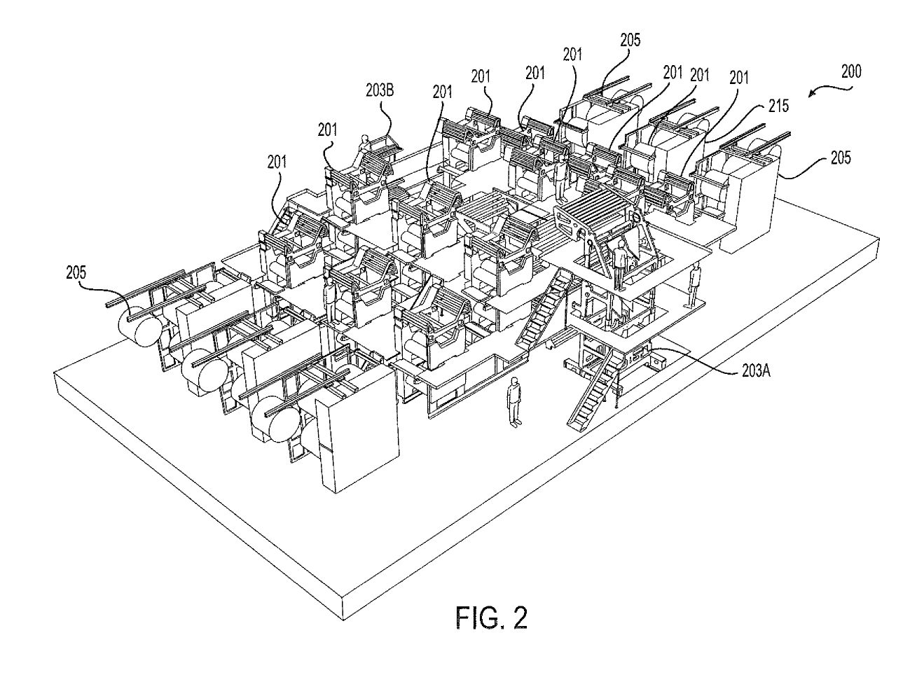

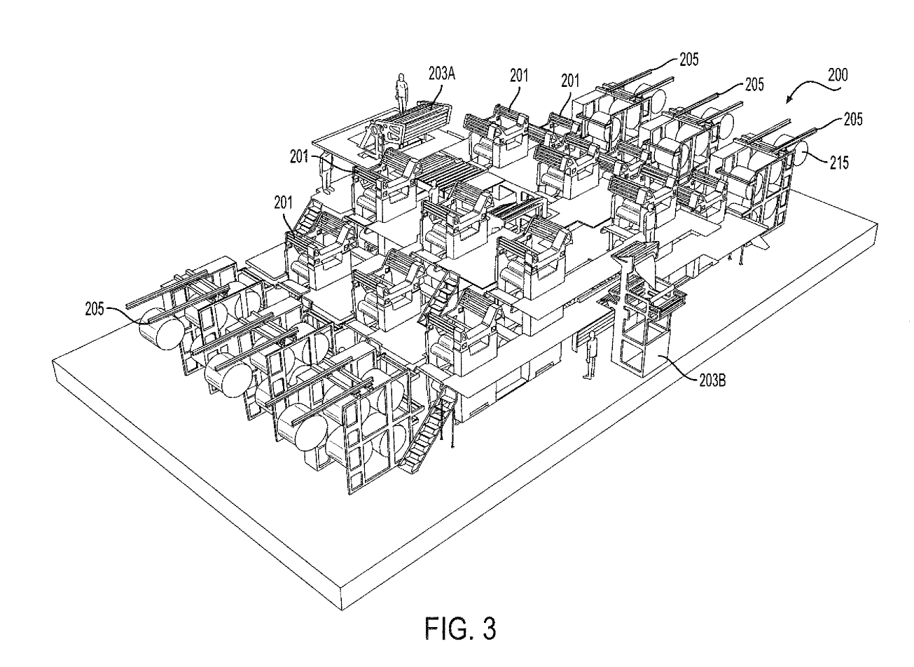

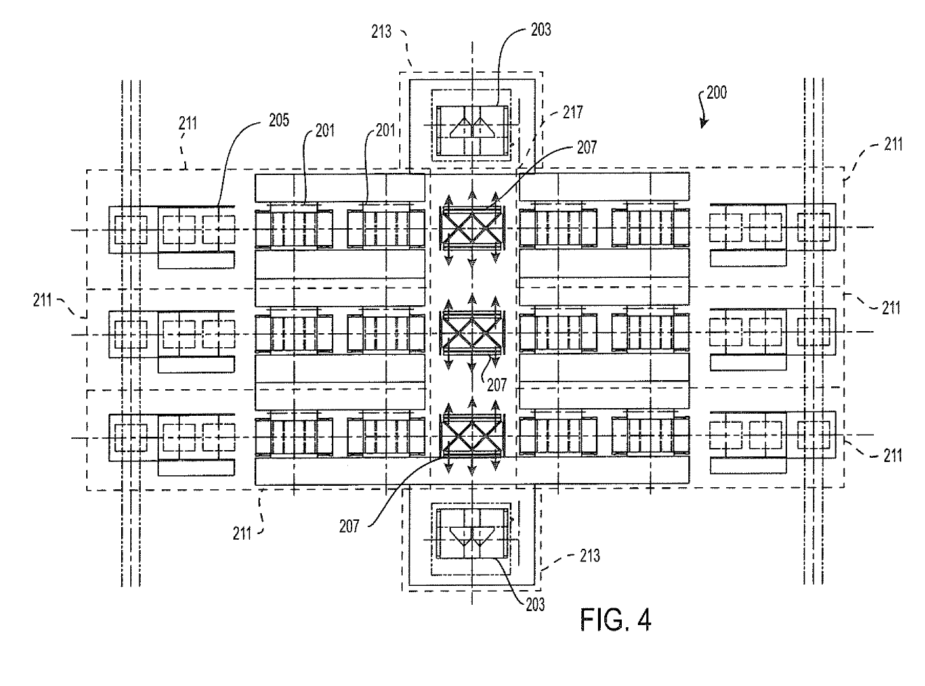

FIGS. 2-3 provide various depictions of an embodiment of a pressline module (200) which is designed to have a more compact footprint while providing flexibility in printing options and a modular design. The pressline module (200) of FIG. 2 will essentially comprise similar or greater capacity to a standard linear pressline of the prior art and is shown in FIGS. 2-3 as including twelve press units (201), two folders (203A) and (203B), and six paper sources (205). FIG. 4 shows a nearly identical embodiment except that the two folders (203) are the same size and can be either the large capacity folder (203A) or the smaller secondary folder (203B) which is why the basic reference indicator with no letter is used. As discussed previously, a traditional pressline arrangement would usually have had 8-10 press units a single folder and anywhere from two to ten paper sources.

In the arrangements of FIGS. 2-4, the pressline module (200) can be broken into three major subcomponent types as best shown in FIG. 4. The pressline module (200) comprises six modular print zones (three on each side facing each other) (211) each of which comprises two printing units (201) and at least one paper source (205). It also includes a turn zone (217) which is located in the space between the facing print zones (211) which is provided with a series of angle bars (207) where a set of angle bars (207) is positioned between each facing print zone (211) pair. It also includes two folder zones (213). Each folder zone (213) comprises at least one folder (203) which is positioned outside the turn zone (217) (that is not between the print zones (211) and offset with the press units) and is arranged to be out-of-line with the press units (201).

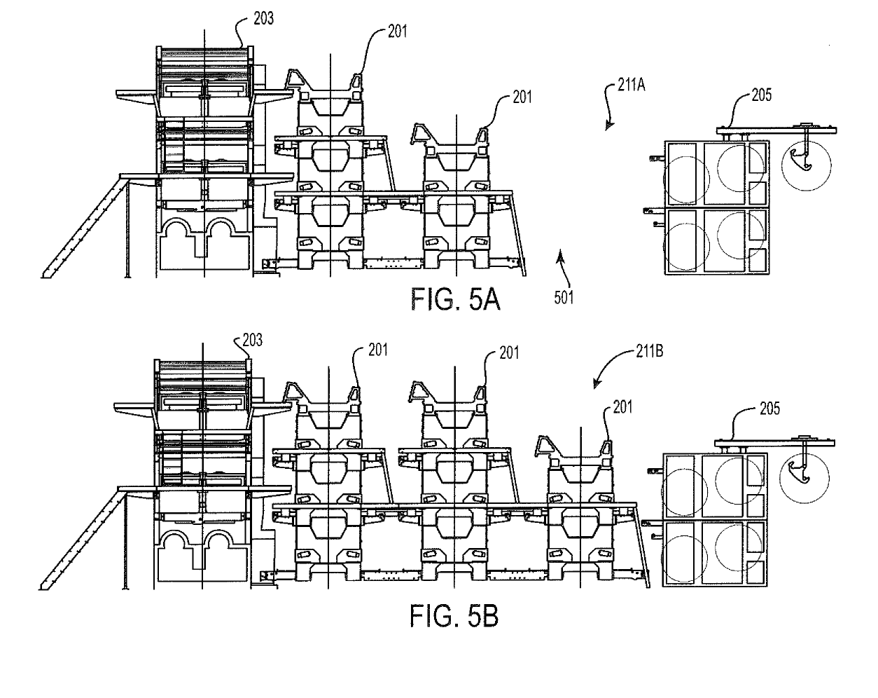

While the embodiments of FIGS. 2-4 provide that each of the six print zones (211) comprises two print units (201), this is not required. Each print zone (211) will generally comprise either two or three press units (201) and at least one source of paper. However, a print zone (211), in some layouts, can comprise a single press unit and paper source and may comprise any larger number of press units and paper sources. FIG. 5A provides for an embodiment of a two press unit print zone (211A) and FIG. 5B provides for an embodiment of a three press unit print zone (211B). It should be recognized that the embodiments of FIGS. 5A and 5B depict well-known heavy duty single width press units (such as a Goss Urbanite™ unit) arranged into larger press units (201) which each comprise two or three of the heavy duty single width press units as subcomponents, but this is done simply to provide a depictable embodiment. Further, FIGS. 5A and 5B, due to their detail, illustrate how the folder (203) is arranged at an angle to the press units (201) as discussed later. Further, while FIGS. 5A and 5B provide for the different kinds of press units (201) to be in a particular order (taller units closer to the folder) this is not required and in some embodiments it is expected that the press units (201) will be posited in exactly the reverse order to that depicted in FIGS. 5A and 5B with the taller units toward the paper sources.

Generally, the print zones (211B) of FIG. 5B will be used where full color capability of the print zone (211) is desired (as this will allow the print zone (211) to print two paper webs with full color on both sides) and the print zone (211A) of FIG. 5A will be used where at least some of the pages are intended to be printed in black and white as this will allow for two paper webs to be printed with one in black and white and one in full color. The width of the press units (201) in either print zone (211A) or (211B) can be either single wide, three page, or double wide depending on the desire of the pressline operator. However, the modular pressline (200) is particularly useful when single wide or three page width is used as it allows for use of smaller presses to provide for expanded capability.

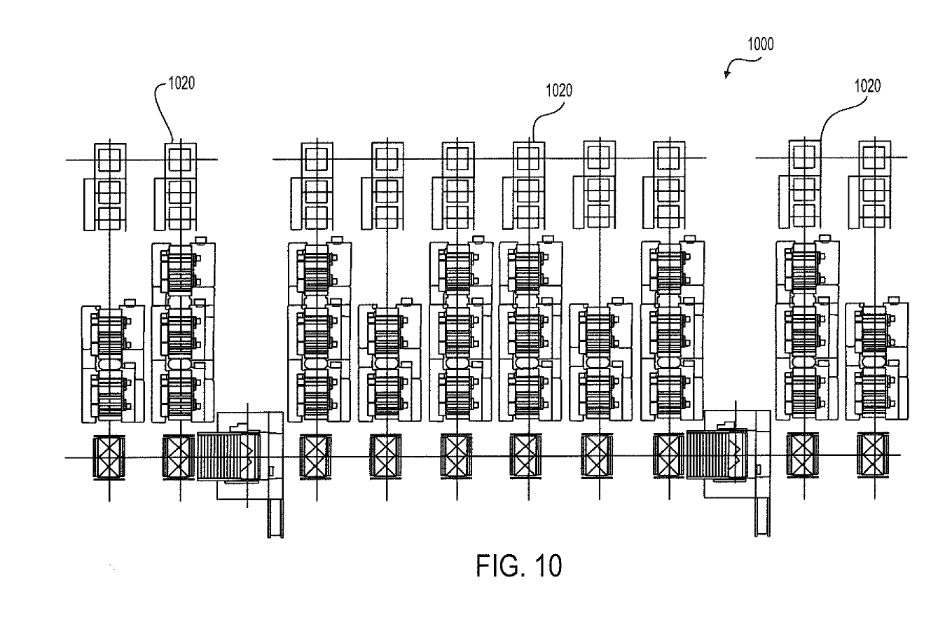

In the embodiment of FIG. 5A, there is a purposeful gap (501) left where a third press unit (201) could be. This is not necessary but can allow the print zone (211A) to be built for future expansion of a two unit (511A) to a three unit print zone (211B), or could be used if a resultant pressline module (200) or pressline includes both 2 and 3 unit print zones (211A) and (211B) to better standardize the paper travel distance from paper source (205) to folder (203). One such example is shown in FIG. 10.

As can be seen in FIGS. 5A and 5B as well as FIGS. 2-4, each print zone (211A) and (211B) will generally also include a source of paper (205). This will be a series of rolls and the paper source (205) may be positioned at any point relative to the press units (201). It is generally preferred that the paper source (205) be arranged behind the press units (201) (as in FIGS. 5A and 5B), under the press units (201), e.g. as provided in FIG. 1, or beside the press units (201) with the positioning generally selected based on the desired footprint and height of the pressline module (200).

In the arrangements of FIGS. 2-4, each of the print zones (211) comprises just two press units (201) for simplicity of discussion and as this will often provide plenty of print capacity for a standard newspaper. However, some or all could easily be replaced by three press unit (201) print zones (211B) in alternative embodiments which is why FIGS. 2-4 utilize the reference indicator (211) instead of (211A) or (211B). The print zones (211) are arranged in a three-on-three facing arrangement. That is, three right-side print zones (211) (as viewing FIG. 4) are arranged to face left and the three left side print zones (211) are arranged to face right. Facing here is indicated as the direction that the paper web will generally leave the last press unit (201) in the print zone (211) as viewed in the view of FIG. 4.

Between the opposed facing press zones is the turn zone (217) where there will generally be a set of angle bars (207) located between each facing set of print zones (211) which can be used to direct the various paper webs toward a folder zone (213) as contemplated later in this disclosure. It should be apparent that any two in-line facing print zones (211) are in a standard linear pressline arrangement of the prior art, except that there is no folder (203) between them. Instead, in the position of the folder (203) there is a set of angle bars (207) in the turn zone (217).

Arranged at what is called the “front” of the pressline module of FIGS. 2-4 (the top of FIG. 4), is a first folder zone (213). It should be noted that the folder zone (213) generally includes at least one folder (203) and the folder (203) is specifically arranged in the folder zone (213) to not be in-line with any of the press units (201) or print zones (211). That is, the direction the paper web enters the folder (203) is not coaxial or parallel with the direction in which the paper web would exit any press unit (201) (as viewed in the horizontal plane). Instead, the folder (203) in the first folder zone (213) it is arranged at a generally 90 degree angle to the line of the paper web through the print zones (211). Further, the folder zone (213) is offset to the line of output of all the print zones (211).

In the depicted embodiment, a folder zone (213) is in front of all the print zones (211) and a second folder zone (213) is behind all the print zones (211). To put this another way, the output paper web of any print zone (211) generally cannot go straight from the print zone (211) into any folder (203). Instead, the paper web will be turned in the turn zone (217) after it has exited the final press unit (201) of any print zone (211), generally about 90 degrees, and will then be routed into the folder (203). The paper web is generally not cut by a slitter prior to entering the folder (203), it is simply turned using angle bars (207) or a similar technology.

It should be recognized that while this application discusses that the turn is generally 90 degrees, this is in no way intended to limit the possible arrangement. Instead, as is indicated in the figures, the primary difference here is that no folder (203) is positioned “in-line” with the press units (201). That is, the direction of paper web inputs into the folder (203) is neither co-axial nor parallel with the direction the paper web exits any press unit (201) when viewed in the horizontal dimensions of FIG. 4. Instead, the folders (203) are positioned “off-to-the-side” of the line of press units (201) and at an angle relative to the angle that the paper web passes through the press units (201). Thus, the web, upon exiting the press unit (201), must be turned before it is allowed to enter the folder (203).

In its simplest viewing, the turned and offset relationship between the folder zone (213) and each print zone (211) would not appear to provide any benefit. Specifically, this arrangement requires the inclusion of a turn zone (217) which was previously unnecessary. The advantage, however, is that any number of print zones (211) can be combined with any folder zone (213) to create a sub pressline within the pressline module (200). This provides an enormous amount of flexibility to the pressline module (200) and resultant pressline.

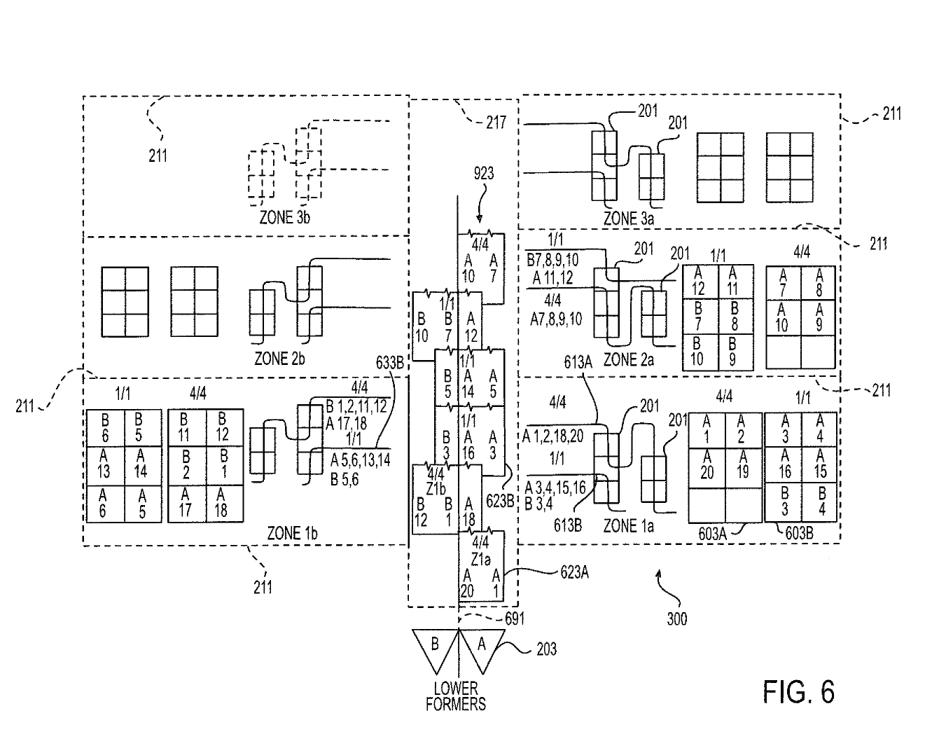

FIG. 6 provides for an example of how the paper webs, and ultimately the paper sheets, can flow from a variety of print zones (211). In FIG. 6, a variation on the arrangement of FIGS. 2-4 is provided. Here the pressline module (300) comprises spaces for six print zones (211), however only five are actually used, the sixth (zone 3b) is vacant. Like in FIGS. 2-4, each of the press zones (211) comprises two, two unit modular presses (201) as illustrated in FIG. 5A. Each is also provided as a three page press unit (201) which is capable of printing three pages of a newspaper beside each other if an appropriately sized paper web is used, or just 2 pages if a narrower web is used. These particular press units (201) and print zones (211) are provided in this embodiment of FIG. 6 as this provides for a more complicated print pattern which is useful for illustrating the flexibility in the pressline module (300).

First shown in each print zone is an indication (603A) and (603B) of how the two paper webs in that zone are to be printed. This is best illustrated by example. The pressline module (300) as depicted is arranged to print a paper with two sections (A and B). Each paper page to be printed in the zone indicates the section (A or B) and the specific page to be printed. In this arrangement, for example, in zone 1a pages A1 and A20 are printed on the first side of the web (613A) (the right column) and on the opposing side of the paper web (613A) pages A2 and A19 (left column) are printed as shown in the indication (603A). This is a standard quadrifold page of a newspaper. Further, the page (603A) is in full color as it will pass through 4 plate/blanket sets to generate full color on all the pages printed in that web (613A). It should be noted that the bottom row of this indicator (603A) is blank as the web (613A) in this case is only single wide (as opposed to three page) so these spaces indicate “blank” plates where nothing is printed.

Further, zone 1a also prints a three page web (613B) with pages A3, A16, and B3 on one side and A4, A15, and B4 on the other as indicated at (603B). This page (603B) as indicated is black and white as it only passes through a single plate/blanket combination. The indication of the zone 1a also shows one possible paper path through the two print units in the zone which can obtain this printing with the path of both the webs (613A) and (613B) through the press units (201). The resulting pages (623A) and (623B) are also shown as they will be arranged for folding. This pattern of drawings is repeated for the remaining print zones 1b through 3a to illustrate where each of the pages of both the sections is printed, how it is printed on the web, how the web passes through the print units (201), and how the pages are arranged entering the folder. As should be apparent, the newspaper being printed is sufficiently small that Zone 2b and 3a are not necessary to print any pages and are sitting idle.

Once the pages are printed, they are arranged as shown in the center of the drawing to enter the folder (203). The center of FIG. 4 provides for the center line (691) of the folder (203) and therefore illustrates how the pages (e.g. (623A) and (623B)) will enter the folder (203). Pages to the left of the center line (691) will be folded together to form section B and those on the right are folded together to form section A. Pages which cross the center line (e.g. page (623B)) will be cut by the folder (203) along the center line allowing that web to feed pages to both sections. The line of pages (923) is specifically shown as indicated because at this time the various paper webs (e.g. (613A) and (613B)) have all been rotated 90 degrees from their position coming out of the print zones (211) and having been turned by the turn zone (217). Further, they are not show in the order of their source print zones (211), but are shown interleaved so that the pages are in the appropriate order.

As should be apparent from FIG. 6, the pages in the line (923) are not arranged in a traditional fashion. For example the output of zone 1b is interleaved with the output of zone 1a. In a traditional print setup with the folder in-line with these two lines of press units, this would be impossible. Specifically, it would have required the lower web from one side (e.g. the black and white web (633B) from zone 1b) to have passed through the upper web (the color front page web (613A) of zone 1a) of the other. However, because of the turn zone (217), this is possible in the depicted embodiment.

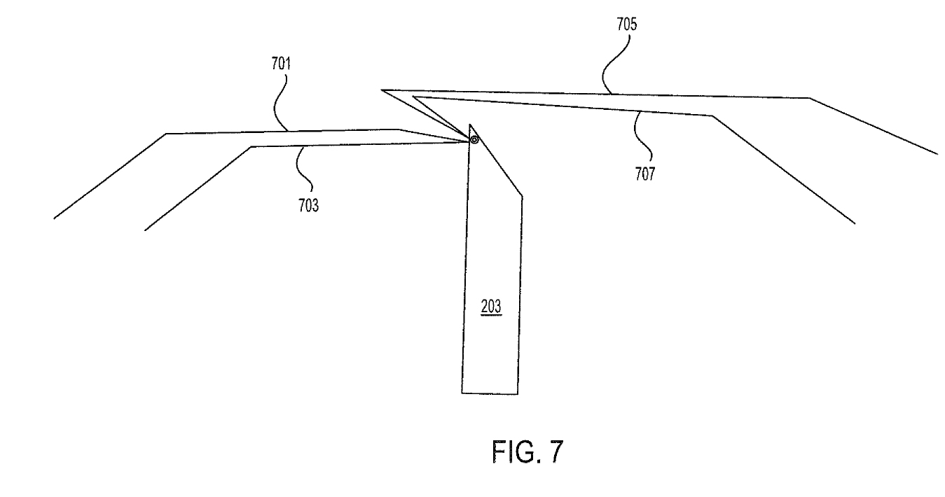

It should be apparent based on the above description and associated figures how the 90 degree turn introduction of the turn zone (217) allows the pages to be interleaved as shown in FIG. 6. In particular, if the folder (203) was in-line, the two pages output from zone 1a would need to remain on top of each other (they still do in FIG. 4), but would generally both need to be above or below both the paper webs coming from zone 1b (based on the direction the folder (203) is facing). This is because two of the webs would be coming in over the other two and the lower most of the top webs cannot pass through the uppermost of the bottom webs. This is illustrated in the side view of the meeting webs in FIG. 7. Specifically, in FIG. 7, webs (701) and (703) have a relative fixed position which is below webs (705) and (707) and each pair of webs also has a fixed position relative the other web from the same side. As should be apparent, the relative position of the webs (701) and (703) is also different form (705) and (707).

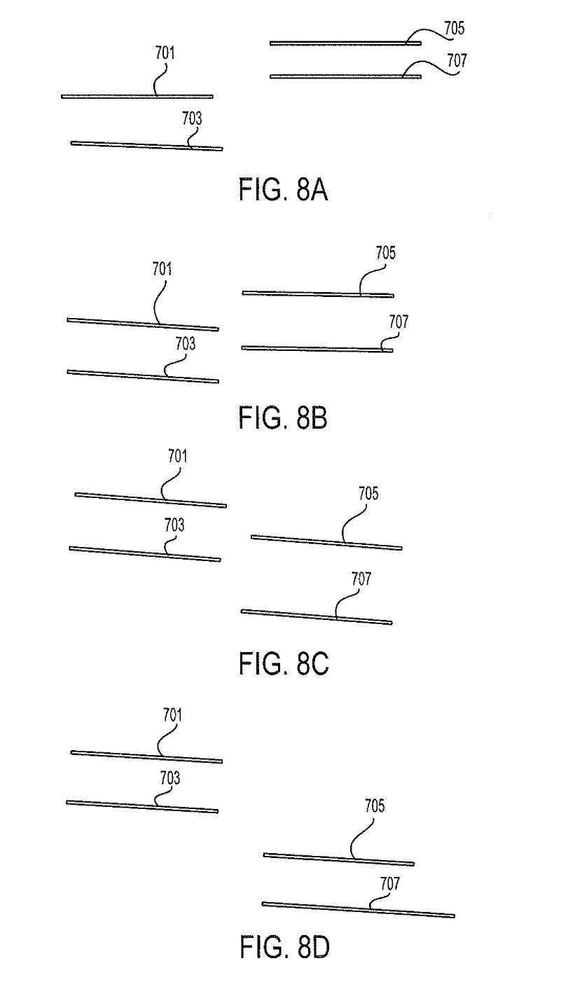

As shown in FIGS. 8A-8D, however, as the webs (701), (703), (705) and (707) are turned in the turn zone of the present pressline module, the webs (701), (703), (705) and (707) can be arranged in essentially any arrangement leaving the turn. This is because as the webs (701), (703), (705) and (707) are coming directly at each other (they do not have to go around or into the folder in-line), one set does not need to be above the other. Instead, because the folder in essentially in the position of the viewer of FIGS. 8A-8D, the webs (701), (703), (705) and (707) can be interleaved at any desired arrangement, and are then aligned from that arrangement to enter the folder. Further, it should be apparent that the output of lower zones (e.g. zone 2a) can also be interleaved at any point in the arrangements of any of FIGS. 8A-8D. This means that any page can be printed in any zone.

Further, the flexibility of paper flow through the zone, means that even to the extent that a zone will still require the top web to be above the lower web from that same zone (there is no need to reverse as may be the case as is indicated in FIG. 7), which page (along with the specifics of its color and size) printed in which position of each zone is freely alterable. For example, it should be apparent that zone 1a in FIG. 6 produces an upper web that is single wide and full color and a bottom web that is three page and black and white, while zone 2a produces a very different arrangement with a three page upper web in black and white and a lower singe wide web in color.

This customization of being able to select to print any page at essentially any position simply does not exist in current presslines and provides for an enormous number of benefits. In the first instance, the most important pages of a paper (e.g. the first and last) can be printed in any of the print zones. As shown in the embodiment of FIG. 6, the first pages of each section are printed on the uppermost zones 1a and 1b (those zones closest to the folder (203)). This means that these pages will have the shortest travel path from the last press unit (201) to the folder (203) and can be under the least amount of tension. In turn, this provides the pressline operator with the most control over the most important webs.

Further, as the outermost pages will enter the folder on the top of the web stack (since those pages by definition need to be outermost after folding), the pages that have to travel further (e.g. those from zone 2a in FIG. 6 or that would be from 2b or 3a if those zones were operating) and have to be under the most tension, can be the middlemost pages which are on the bottom entering the folder (203). This allows those longer traveling pages to be the least important pages and allows the operator to place the webs under the highest tension underneath the web stack. It is simple mechanics to understand that placing the highest tension at the bottom will actually assist in balancing the tension across the print lines (211) since the lower webs will “drag along” the webs above them as opposed to traditional pages where the highest tension webs were at the top of the stack and generally served to wrinkle other lower webs.

While the ability to position higher and lower tension webs wherever is desired is beneficial, placement of the press units (201) in the depicted zone and module configuration also serves to dramatically shorten the maximum paper web distance from the furthest press unit (201) to the folder (203), and also makes the distances much closer together. For example, in the embodiment of FIG. 6 it should be apparent that the distance from the last press unit in zone 3a (which is basically the width of zones 1a and 2a) is clearly less than it would be in a linear pressline arrangement where the output of zone 3a would have to pass over the length of zones 1a and 2a.

Thus, the tension which each of the paper webs is under is more standardized. While there is variation, the standard deviation of the tensions is clearly much smaller than in prior art presslines. This means that the webs are generally under a more similar tension and problems created by having the webs under significantly different tensions are reduced. Specifically, wrinkling from having to place webs of different tensions in proximity are reduced as is the likelihood of high tension long webs suffering damage.

As shown in FIG. 6, it is generally expected that a press operator will operate the modular pressline so that the outmost pages of the newspaper will be printed in the print zones (211) closest to the folder (203) to reduce web travel distance between press unit and folder and to allow for less space to be taken up. However, because the pages can be interleaved in any order, it is entirely up to the press operator as to how they want to generate any particular paper. This means that the number of pages can be much more easily varied, as can the specifics of which units are used to print those pages. Thus, for example, a paper can utilize a larger, three unit module to print the front page of certain editions where the front page is to be in full color, and can use a small modular line to print the paper if the front page of a certain edition is in black and white. This type of flexibility is simply impossible with today's commercial press lines.

In addition to allowing for flexibility in how any particular edition of the paper is printed, the system also allows essentially all press units (specifically all the print zones) that are not currently in use to be used to print secondary products. This capability is generally provided by having a second folder zone (213) which is arranged below the print zones (211) as shown in FIGS. 2-4. In the depictions of FIGS. 2-3, the folder (203B) in this secondary folder zone (213) is significantly smaller than the folder (203A) in the primary folding zone. In particular, the depicted folder of FIGS. 2-3 only can fold a single section and is intended to be used for smaller and more specific print runs.

As should be apparent, it is expected that the output of all the print zones (211) would not be simultaneously run through this folder (203B) and, in fact, only the output of half or less of the print zones (211) would ever be run through it. This is because for any two projects being printed, the one utilizing the most print zones (211) (anywhere from 1 to 6) would always be sent to the primary folder (203A). Therefore, the secondary folder (203B) would only be used for the smaller job of 0-3 modular lines. Again, because the turn zone (217) allows for the output of any print zone (211) to be positioned in essentially any position relative the output of other print zones (211), virtually any paper web arrangement (so long as it is compatible with the secondary folder's (203B) ability to fold) can be carried out and can be done regardless of the arrangement being produced and folded in the other folding zone.

It should be apparent from the above discussion and associated figures that there is significantly more flexibility of the above pressline module (200) or (300) than in any other form of pressline. In the first instance, any combination of print zones (211) within the pressline module (200) or (300) can be used to create any particular paper publication and can print the pages in any order. Further, each pressline module (200) or (300) can produce not just a single publication with this extreme flexibility, but two, or potentially more, publications with the same flexibility with the sole limitation being the capability of the folders (203A) and (203B) to fold the desired publications.

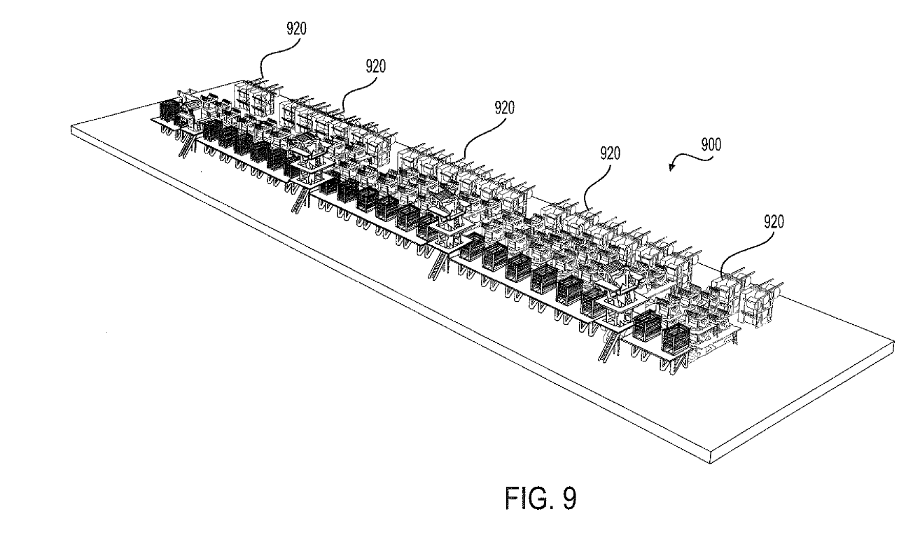

While the embodiment of FIGS. 2-4 contemplates a pressline module (200) with six print zones (211) and two folder zones (213), it should be apparent that the arrangement can be rapidly altered and easily scaled for larger or smaller systems. Specifically, systems with two or more print zones (211), a single turn zone (217), and one or more folder zones (213) can be provided in each pressline module (200). Further, multiple pressline modules (200) or (300) can be combined to form a much larger pressline. FIGS. 9-10 provide for two embodiments of a large pressline. The pressline (900) of FIG. 9 comprises twenty-two print zones (211) arranged in five modules (920). FIG. 10 has a pressline (1000) comprising ten print zones (211) of different sizes arranged in three modules (1020)

The modules (920) and (1020) in FIGS. 9-10 provide for zones which are not arranged facing each other, but all facing the same way. This can be desirable to fit the pressline (900) or (1000) into buildings constructed for more traditional presslines but is not required and the same capacity could be provided with fewer pressline modules if desired.

Further, the pressline of FIG. 9 only has four folders and the pressline of FIG. 10 only has two folders but each maintains nearly all the flexibility of each module as adjacent pressline modules each include access to two folders which each shares with its neighbor. The very end pressline modules, which are significantly smaller in both embodiments of FIGS. 9 and 10, are not provided with access to two folders simply because they are so much smaller than the other modules that they generally would not need access to a dedicated folder.

As indicated above, the arrangements of FIGS. 9-10 can serve to provide a much more flexible print arrangement in a more traditional space than was ever provided in traditional presslines. Each pressline (900) and (1000) generally comprises the capability of a standard full size pressline in a more compact footprint and also serves to provide for significantly enhanced flexibility within the pressline. All this flexibility, and potential space savings, can come without loss of total print capacity, as existing press units and folders from an existing pressline can be repositioned in the depicted arrangements if the existing equipment is suitable for the desired arrangement. While the conversion of a pressline from an existing arrangement to the arrangements discussed here will generally take time and significant effort (as many of the press units and folders need to be moved to new locations within the same space), the modified pressline can provide for significant additional value in utilization of that equipment.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art. Accordingly, it is intended that all reasonably foreseeable addition, modifications, deletions and alterations be included within the scope of the invention as defined in the following claims.

1. A pressline comprising:
a first press zone comprising at least two press units arranged in-line with each other and a paper source supplying a paper web to each of said press units;
a first folder zone comprising at least one folder, said first folder zone being out-of-line and offset to a first side of said press units; and
a turning zone comprising angle bars, said angle bars being positioned so as to take at least one paper web from at least one of said press units and redirect said paper web to said folder;
wherein said at least one paper web in said turning zone is redirected from being in-line with said press units and out-of-line with said folder to being out-of-line with said press units and in-line with said folder.

2. The pressline of claim 1 wherein said at least one paper web in said turning zone is redirected generally about 90 degrees.

3. The pressline of claim 1 further comprising a second folder zone, said second folder zone comprising at least one folder, said second folder zone being out-of-line and offset to a second side of said press units.

4. The pressline of claim 1 further comprising a second press zone, said second press zone comprising at least two press units arranged in-line with each other and a paper source supplying a paper web to each of said press units in said second press zone, said second press zone facing said first press zone.

5. A pressline module comprising:
at least two press units;
at least two folders; and
at least one turn zone comprising angle bars;
wherein a first of said at least two press units is arranged facing said turn zone;
wherein a second of said at least two press units is arranged on an opposing side of said turn zone to said first of said at least two press units, is facing said turn zone, and is in-line with said first of said at least two press units;
wherein a first of said at least two folders is arranged out-of-line with said press units, offset from said press units, and facing said turn zone; and
wherein a second of said at least two folders is arranged on an opposing side of said turn zone to said first of said at least two folders, in-line with said first of said at least two folders, out-of-line with said press units, offset from said press units, and facing said turn zone.

6. The pressline module of claim 5 further comprising at least one paper source supplying a paper web to said press units.

7. The pressline module of claim 5 wherein said at least two press units comprises at least six press units.

8. The pressline module of claim 7 wherein said press units are arranged in at least three groups of press units;
wherein a first of said at least two press units in a first group is arranged facing said turn zone and a second of said at least two press units in said first group is arranged on an opposing side of said turn zone to said first of said at least two press units, is facing said turn zone, and is in-line with said first of said at least two press units in said first group;
wherein a first of said at least two press units in a second group is arranged facing said turn zone and a second of said at least two press units in said second group is arranged on an opposing side of said turn zone to said first of said at least two press units, is facing said turn zone, and is in-line with said first of said at least two press units in said second group;
wherein a first of said at least two press units in a third group is arranged facing said turn zone and a second of said at least two press units in said third group is arranged on an opposing side of said turn zone to said first of said at least two press units, is facing said turn zone, and is in-line with said first of said at least two press units in said third group.

9. The pressline module of claim 8 wherein said at least six press units comprises at least twelve press units and each of said at least three groups of press units comprises at least two press units.

10. The pressline module of claim 9 wherein said at least twelve press units comprises at least eighteen press units and each of said at least three groups of press units comprises at least three press units.

11. A pressline comprising at least two pressline modules of claim 10.

12. A pressline comprising at least two pressline modules of claim 9.

13. A pressline comprising at least two pressline modules of claim 8.

14. A pressline comprising at least two pressline modules of claim 5.
